(19) United States
(12) Patent Application Publication
(10) Pub. No.: US 2026/0084326 A1
(43) Pub. Date: Mar. 26, 2026

(54) ROBOTIC INSPECTION SYSTEM WITH NON-PLANAR OPTICAL ELEMENT

(71) Applicant: Intel Corporation, Santa Clara, CA (US)

(72) Inventors: David Israel Gonzalez Aguirre, Hillsboro, OR (US); Rodrigo Aldana Lopez, Zapopan (MX); Cornelius Buerkle, Karlsruhe (DE); Javier Felip Leon, Hillsboro, OR (US); Javier Felix Rendon, Zapopan (MX); Roderico Alfredo Garcia Leal, Zapopan (MX); Celal Savur, Hillsboro, OR (US); Julio Zamora Esquivel, West Sacramento, CA (US)

(21) Appl. No.: 19/403,464

(22) Filed: Nov. 28, 2025

(51) Int. Cl. B25J 19/02; B25J 9/16; B25J 17/02; G06T 5/80; G06T 7/529; G06T 7/55; G06T 7/70; H04N 23/55; H04N 23/69; H04N 23/695

(52) U.S. Cl. CPC B25J 19/023; B25J 9/1676; B25J 9/1697; B25J 17/0283; G06T 5/80; G06T 7/529; G06T 7/55; G06T 7/70; H04N 23/55; G06T 2207/10028; G06T 2207/20081; G06T 2207/20084; H04N 23/69; H04N 23/695

(57) ABSTRACT

The present disclosure provides a robotic inspection system including a robotic platform, a non-planar optical element mounted via a multi-degree-of-freedom actuator system configured to controllably position and orient the optical element, wherein the optical element introduces non-linear distortion into reflected images. The system further includes an imaging system with a camera mounted to the robotic platform and configured to capture images reflected from the optical element at different orientations. The system also includes a processing system configured to receive the captured images from the imaging system, receive positional information corresponding to the different orientations of the optical element and imaging system, and process the images with the positional information to compensate for non-linear distortion and generate three-dimensional depth information of a target object within the imaging system's field of view.

### TECHNICAL FIELD

The present disclosure relates to robotic inspection systems for industrial environments, and more particularly to a robotic inspection system utilizing a non-planar optical element with multi-degree-of-freedom actuation to enable three-dimensional reconstruction and visual inspection in spatially constrained areas through controlled distortion imaging and neural network-based depth estimation.

### BACKGROUND

Industrial facilities, warehouses, and manufacturing environments contain complex arrangements of machinery, piping, valves, and instrumentation that require regular visual inspection and monitoring. These inspections often involve accessing confined spaces, narrow passages, and areas with limited clearance where traditional sensing approaches face operational constraints.

Conventional robotic inspection systems typically employ standard cameras, LiDAR (Light Detection and Ranging) sensors, or stereo vision systems that operate under pinhole camera model assumptions. These systems encounter limitations when operating in spatially constrained environments due to minimum object distance requirements, restricted fields of view, and line-of-sight dependencies. The geometric constraints of traditional optical systems can prevent adequate imaging of targets positioned in narrow corridors, behind machinery, or within enclosed spaces.

Mobile robotic platforms, including wheeled autonomous mobile robots and legged systems, have been deployed for inspection tasks in industrial settings. However, existing solutions often rely on heavily instrumented sensor packages that increase system weight, complexity, and power consumption. These factors can limit operational duration and restrict access to areas with challenging terrain or tight spatial constraints.

Three-dimensional reconstruction and depth estimation techniques have advanced through the development of neural networks capable of inferring spatial information from visual data. However, conventional approaches typically process images captured through standard optical systems without accounting for controlled optical distortions that could potentially expand sensing capabilities.

The integration of reflective optical elements with robotic systems has been explored in various contexts, but existing implementations generally focus on extending the field of view rather than leveraging controlled distortion for enhanced depth perception and spatial reconstruction in confined environments.

### BRIEF DESCRIPTION OF THE FIGURES

Non-limiting and non-exhaustive examples are described with reference to the following figures.

FIG. 1 illustrates a robotic inspection system with a parabolic mirror, according to aspects of the present disclosure.

FIG. 2 depicts a flowchart of the robotic inspection system process, according to an embodiment.

FIG. 3 illustrates a processing system for deep-reflective modeling, according to aspects of the present disclosure.

FIG. 4 depicts a block diagram of the control system, according to an embodiment.

FIG. 5 illustrates a computing device for the robotic inspection system, according to aspects of the present disclosure.

### DETAILED DESCRIPTION

The following description sets forth exemplary aspects of the present disclosure. It should be recognized, however, that such a description is not intended as a limitation on the scope of the present disclosure. Rather, the description also encompasses combinations and modifications to those exemplary aspects described herein.

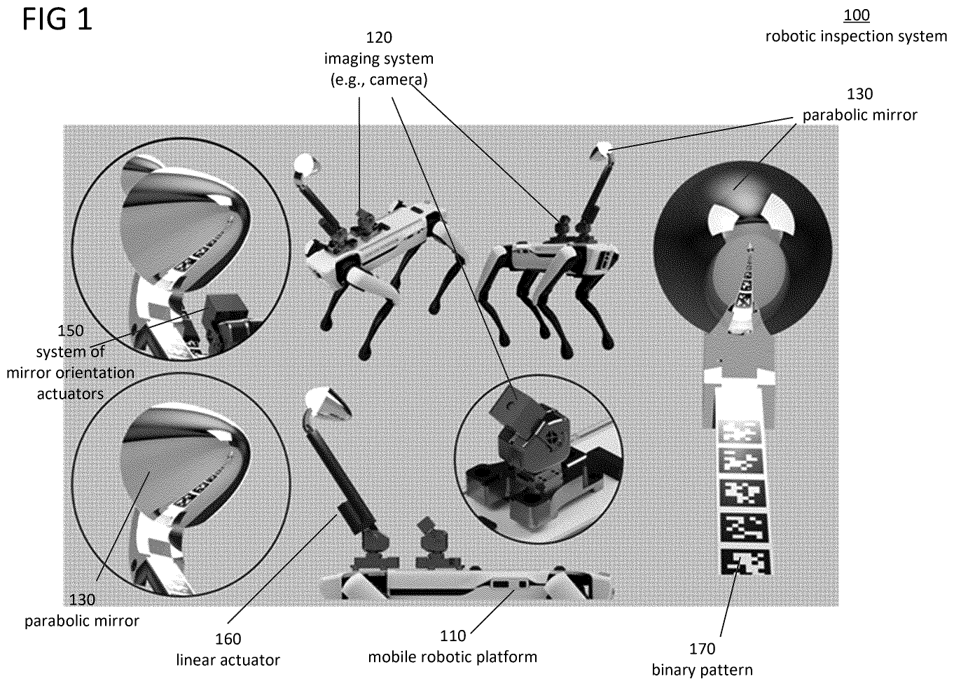

Referring to FIG. 1, a robotic inspection system 100 may be deployed in industrial environments to perform visual inspection and three-dimensional reconstruction tasks. The robotic inspection system 100 may comprise a mobile robotic platform 110 that provides mobility and positioning capability for the inspection system. In some cases, the mobile robotic platform 110 may be configured as a quadruped robot with articulated legs, enabling navigation over varied terrain and obstacles such as stairs. The mobile robotic platform 110 may serve as a base for mounting and transporting optical sensing components and may be configured to navigate to inspection locations.

The robotic inspection system 100 may further include an imaging system 120 mounted on the mobile robotic platform 110. The imaging system 120 may comprise a camera with pan-tilt-zoom capabilities for capturing reflected images during inspection operations. In some cases, the imaging system 120 may include high-resolution cameras for dynamic adjustment of the field of view. The imaging system 120 may be configured to capture a plurality of images reflected from a non-planar optical element at different orientations of the non-planar optical element.

As shown in FIG. 1, the robotic inspection system 100 may include a parabolic mirror 130 that functions as a non-planar optical element. The parabolic mirror 130 may be a non-planar reflective mirror that introduces controlled non-linear distortion into reflected images. The parabolic mirror 130 may be positioned to reflect views of target objects or regions toward the imaging system 120. In some cases, the parabolic mirror 130 may be implemented using different non-planar geometries suitable for specific applications, and the non-planar optical element may not be limited to parabolic shapes.

The robotic inspection system 100 may further comprise mirror orientation actuators 150 coupled to the parabolic mirror 130. The mirror orientation actuators 150 may provide rotational control of the mirror's orientation in multiple degrees of freedom, including pan and tilt movements. The mirror orientation actuators 150 may enable adjustment of the parabolic mirror 130 to achieve different orientations for capturing varied perspectives of target objects.

With continued reference to FIG. 1, a linear actuator 160 may be mechanically connected to support the parabolic mirror 130 and the mirror orientation actuators 150. The linear actuator 160 may provide extension and retraction capability, allowing the parabolic mirror 130 to be positioned at varying distances from the mobile robotic platform 110. The linear actuator 160 may be configured to extend and retract the non-planar optical element as part of a multi-degree-of-freedom actuator system.

The robotic inspection system 100 may include a binary pattern 170 positioned adjacent to the linear actuator 160. The binary pattern 170 may comprise a series of contrasting elements arranged in a coded sequence that may be detected by the imaging system 120 to determine the extension state of the linear actuator 160. The binary pattern 170 may provide visual reference markers for calibration and position encoding.

The multi-degree-of-freedom actuator system may be configured to provide at least five degrees of freedom to controllably position and orient the non-planar optical element. In some cases, the multi-degree-of-freedom actuator system may comprise the linear actuator 160 configured to provide extension and retraction of the non-planar optical element, a first rotational actuator configured to provide pan movement, a second rotational actuator configured to provide tilt movement, and two additional rotational actuators configured to provide angular orientation control at a base of the non-planar optical element. The multi-degree-of-freedom actuator system may be configured to controllably position and orient the non-planar optical element, and the non-planar optical element may be configured to introduce non-linear distortion into reflected images.

Further shown in FIG. 1, the robotic inspection system 100 may further comprise a second multi-degree-of-freedom actuator system configured to control the imaging system 120. The second multi-degree-of-freedom actuator system may provide pan, tilt, and zoom control capabilities for the imaging system 120, enabling dynamic adjustment of the camera's field of view and orientation.

The non-planar optical element may enable imaging of target objects at distances closer than a minimum focus distance of the imaging system 120 operating without the non-planar optical element. This capability may address inspection needs in narrow passages and confined spaces where conventional imaging methods may be constrained by spatial limitations. In some cases, the imaging system 120 may be configured to be invariant to most reflective and translucent materials during inspection operations.

The robotic inspection system 100 may be implemented using different types of robotic platforms, including quadruped robots, autonomous mobile robots, or other mobile robotic aspects. The robotic inspection system 100 may store and utilize 14-dimensional point-of-interest vectors that define the robot base pose with six degrees of freedom, the mirror configuration with five degrees of freedom, and the camera subsystem parameters with three degrees of freedom.

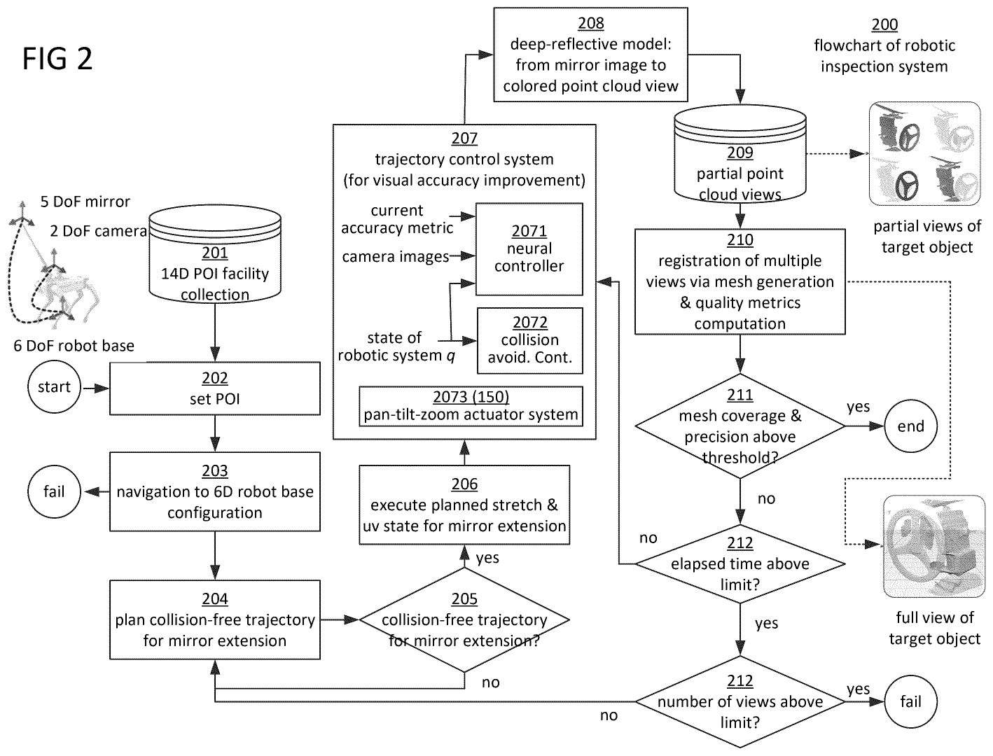

Referring to FIG. 2, a flowchart 200 illustrates the complete process for performing a visual inspection and three-dimensional reconstruction using the robotic inspection system 100. The flowchart 200 represents a systematic approach for managing inspection operations from initial configuration through final reconstruction quality assessment.

The process may begin with a facility collection 201 that stores points of interest for inspection operations. The facility collection 201 may include 14-dimensional point-of-interest vectors that define inspection locations and configurations. Each point of interest vector may comprise six degrees of freedom for the robot base position, five degrees of freedom for the mirror orientation actuators 150 configuration, and three degrees of freedom for camera parameters. The facility collection 201 may provide the foundational data structure for organizing and accessing inspection targets within industrial environments.

As shown in FIG. 2, the process may proceed to step 202, where a point of interest for the inspection task is set. Step 202 may involve selecting a specific inspection target from the facility collection 201 based on operational requirements or inspection schedules. After step 202, the flowchart 200 may advance to step 203 to navigate to a six-dimensional robot base configuration. Step 203 may involve positioning the mobile robotic platform 110 at the designated location corresponding to the selected point of interest.

The flowchart 200 may continue to step 204, which involves planning a collision-free trajectory for mirror extension. Step 204 may use motion-planning algorithms to determine safe deployment paths for the parabolic mirror 130 and its associated actuator systems. The process may then proceed to step 205, which determines whether a collision-free trajectory for mirror extension exists. In cases where no collision-free path can be identified, step 205 may direct the process back to step 204 for replanning.

When a collision-free trajectory may be available, the flowchart 200 may advance to step 206, where the robotic inspection system 100 executes a planned stretch and uv state (2 degrees-of-freedom: Mirror orientation (u, v)) for mirror extension. Step 206 may involve deploying the linear actuator 160 and positioning the parabolic mirror 130 according to the planned trajectory while maintaining safe clearances from obstacles.

With continued reference to FIG. 2, the process may enter a trajectory control system 207 that manages the dynamic control of actuator systems during inspection operations. The trajectory control system 207 may be configured to dynamically control the multi-degree-of-freedom actuator system based on an accuracy metric to adjust viewpoints of target objects. The trajectory control system 207 may comprise a neural controller 2071 that generates actuator control commands based on the accuracy metric and captured images from the imaging system 120. The neural controller 2071 may process current accuracy metrics, camera images, and robotic system state information to determine optimal actuator motions for improving visual accuracy.

The trajectory control system 207 may further include a collision avoidance controller 2072 configured to ensure collision-free motion execution. The collision avoidance controller 2072 may implement control barrier functions to achieve real-time obstacle avoidance during actuator motion. The collision avoidance controller 2072 may operate continuously to prevent collisions while the neural controller 2071 optimizes inspection viewpoints.

As further shown in FIG. 2, the trajectory control system 207 may include a pan-tilt-zoom actuator system 2073 that controls the imaging system 120. The pan-tilt-zoom actuator system 2073 may receive control commands from the neural controller 2071 and collision avoidance controller 2072 to coordinate camera positioning with mirror orientation adjustments.

The accuracy metric utilized by the trajectory control system 207 may comprise point cloud density, coverage completeness, reconstruction uncertainty, or depth estimation confidence. These metrics may provide quantitative measures of reconstruction quality that guide the optimization process during inspection operations. The trajectory control system 207 may operate in real time during image capture to provide feedback that improves the quality of three-dimensional reconstruction.

The flowchart 200 may proceed to step 208, which involves a deep-reflective model that converts mirror images into colored point cloud views. Step 208 may process the distorted images captured through the parabolic mirror 130 and generate three-dimensional depth information with associated texture data. The outputs from step 208 may be stored in partial point cloud views 209 that accumulate multiple perspectives of target objects.

After step 208, the process may proceed to step 210, which registers multiple views via mesh generation and quality metric computation. Step 210 may include coverage assessment, surface smoothness evaluation, and calculations of mean sample points per area. These quality metrics may provide measures of reconstruction completeness and accuracy for subsequent evaluation steps.

The flowchart 200 may continue to step 211, which evaluates whether mesh coverage and precision exceed predetermined thresholds. Step 211 may compare computed quality metrics against application-specific threshold settings for different types of points of interest, making quality limits suitable to the shape and materials of each type. When quality thresholds are met, the process may conclude successfully with completed reconstruction data.

When quality thresholds are not met, the flowchart 200 may proceed to step 212, which checks the elapsed time and the number of view limits. Step 212 may implement temporal bounds and resource constraints to prevent excessive processing time during inspection operations. When time limits are not exceeded, and additional views are available, the process may return to the trajectory control system 207 for continued optimization.

The robotic inspection system 100 may be configured to reposition the mobile robotic platform 110 when the accuracy metric fails to exceed a predetermined threshold within a specified time limit. This replanning strategy may involve volumetric assessment and occupancy checks to ensure collision-free extension of the mirror orientation actuators 150 before deployment at alternative locations. The replanning process may enable the robotic inspection system 100 to adapt to challenging inspection scenarios in which initial positioning may not yield sufficient reconstruction quality.

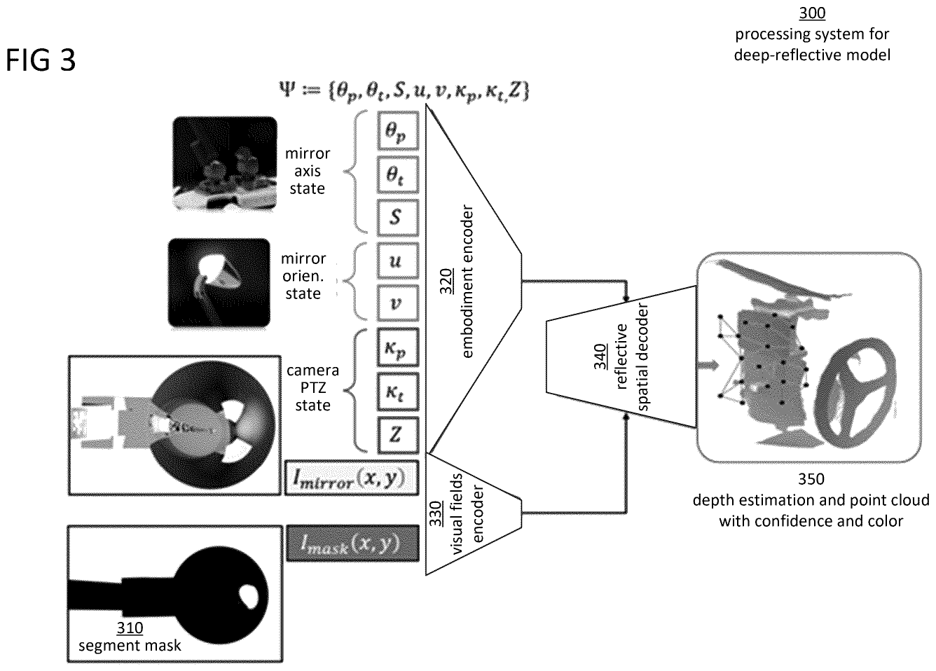

Referring to FIG. 3, a processing system 300 may be configured to receive the plurality of captured images from the imaging system 120 and receive positional information corresponding to the different orientations of the non-planar optical element and the imaging system 120. The processing system 300 may process the plurality of captured images in combination with the positional information to compensate for the non-linear distortion and generate three-dimensional depth information of a target object within a field of view of the imaging system 120.

The processing system 300 may comprise a neural network configured to process the plurality of captured images and the corresponding positional information to generate the three-dimensional depth information. The neural network may receive as input a mirror image Iₘᵢᵣᵣₒᵣ(x, y), a segment mask 310 Iₘₐₛₖ(x, y), and a state vector that defines the mechanical and optical configuration of the system.

As shown in FIG. 3, the processing system 300 may include an embodiment encoder 320 that functions as a configuration encoder configured to encode the state vector Ψ into a configuration vector:

$$Ψ := \{ {θ}_{p} , {θ}_{t} , S , u , v , {κ}_{p} , {κ}_{t} , Z \} , \qquad ( Equation )$$

where θₚ and θₜ represent the mirror axis state angles, S represents the extension parameter, u and v represent the mirror orientation state, and κₚ, κₜ, and Z represent the camera pan-tilt-zoom (PTZ)rgb state parameters. The embodiment encoder 320 may convert the state vector Ψ into an encoded representation that captures the mechanical state of the robotic inspection system 100.

The processing system 300 may further include a visual fields encoder 330, which functions as a visual encoder configured to process captured images to generate scene embeddings. The visual fields encoder 330 may process the mirror image Iₘᵢᵣᵣₒᵣ(x, y) into the segment mask 310 to generate scene embeddings that capture appearance information from the distorted reflective image. The visual fields encoder 330 may analyze the non-linear distortion present in the reflected image captured through the parabolic mirror 130.

With continued reference to FIG. 3, the processing system 300 may include a reflective spatial decoder 340 that decodes the configuration vector and scene embeddings to compensate for non-linear distortion and generate per-pixel depth estimates with texture information in the coordinate frame of the robotic platform. The reflective spatial decoder 340 may receive the outputs from both the embodiment encoder 320 and the visual fields encoder 330. The reflective spatial decoder 340 may fuse the encoded configuration information with the visual embedding to compensate for the optical distortion introduced by the parabolic mirror 130 and to estimate spatial relationships.

In some aspects, the reflective spatial decoder 340 may implement a Deep-Reflective Model configured to transform distorted reflective observations into Euclidean views. For each favorable mirror view, only a small region may contain visual information modified by a non-linear mapping. A Sim2Real-trained network may process the configuration state vector Ψ together with the mirror image Iₘᵢᵣᵣₒᵣ(x, y) and the segment mask Iₘₐₛₖ(x, y) to generate a Euclidean view in the robot base frame. The resulting outputs may comprise structured partial point clouds that can be stitched into a unified mesh representation.

The output of the processing system 300 may be a depth estimation and point cloud 350 that provides three-dimensional reconstruction with confidence values and color information. The depth estimation and point cloud 350 may represent the scene in Euclidean space, transforming the distorted reflective image into metric depth values and spatial coordinates aligned to the robot base frame. The depth estimation and point cloud 350 may provide three-dimensional depth information that comprises texture information for comprehensive inspection capabilities.

The neural network may be trained using simulation-based learning with ray optics modeling of the non-planar optical element to generate training data with ground truth depth annotations. The trained neural network may be configured to operate on real-world captured images. In some cases, the neural network training may utilize reinforcement learning or gradient-based optimization techniques with ray optics simulators for modeling mirror-camera system behavior. The ray optics simulators may model the images captured by the mirror-camera system, enabling evaluation of accuracy metrics directly within the simulated environment.

The processing system 300 may be partitioned between on-board processing and edge computing servers, with image embeddings transmitted to artificial intelligence (AI)-edge servers to optimize energy-to-workload ratios. This distributed processing approach may reduce computational load on the mobile robotic platform 110 while maintaining real-time processing capabilities. In some cases, the processing system 300 may implement workload aggregation where multiple robotic agents connect to a single AI engine for scalable processing. This aggregation approach may enable cost-effective deployment of multiple robotic inspection systems 100 that share computational resources through a centralized processing infrastructure.

The processing system 300 may be configured to generate partial three-dimensional reconstructions from individual captured images corresponding to different orientations of the parabolic mirror 130. The processing system 300 may further be configured to register the partial three-dimensional reconstructions in a common coordinate frame using the corresponding positional information. The processing system 300 may also be configured to spatially align partial three-dimensional reconstructions using the corresponding positional information and generate a mesh surface from the spatially aligned partial three-dimensional reconstructions.

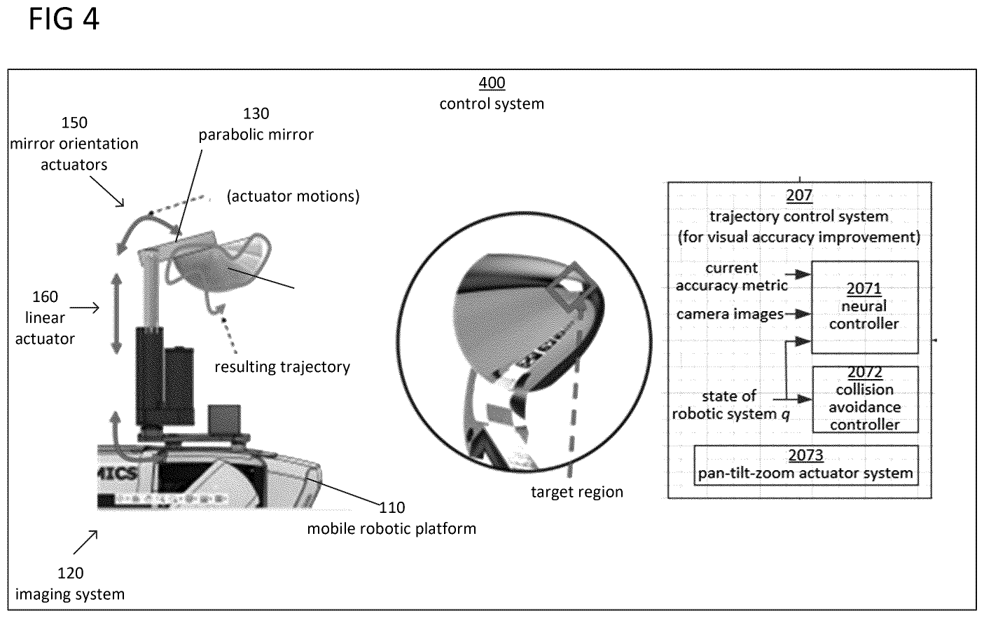

Referring to FIG. 4, a control system 400 may manage the operational integration of the robotic inspection system 100 components. The control system 400 may coordinate the mobile robotic platform 110, the imaging system 120, the parabolic mirror 130, the mirror orientation actuators 150, and the linear actuator 160 during inspection operations. The control system 400 may receive inputs, including a current accuracy metric, camera images from the imaging system 120, and the robotic system's state q, to manage operations throughout the inspection process.

The trajectory control system 207 may process these inputs to generate control commands for the actuator systems. The trajectory control system 207 may receive the current accuracy metric, camera images, and robotic system state information to determine optimal control strategies. The neural controller 2071 may determine optimal actuator motions to improve visual accuracy based on the current accuracy metric and captured images. The neural controller 2071 may analyze the received inputs and generate control commands that maximize reconstruction quality and inspection effectiveness.

As shown in FIG. 4, the collision avoidance controller 2072 may ensure safe operation by preventing collisions during actuator motion. The collision avoidance controller 2072 may implement real-time obstacle-avoidance algorithms, while the neural controller 2071 optimizes inspection viewpoints. The collision avoidance controller 2072 may operate continuously to maintain safe clearances from obstacles and environmental constraints during mirror and camera positioning operations.

The trajectory control system 207 may output control signals to the pan-tilt-zoom actuator system 2073 that controls the imaging system 120. The pan-tilt-zoom actuator system 2073 may receive control commands and coordinate camera positioning with mirror orientation adjustments. The control signals may also be transmitted to the mirror orientation actuators 150 and the linear actuator 160 to achieve synchronized motion of the optical sensing components.

With continued reference to FIG. 4, the imaging system 120 may comprise a single camera configured to capture red, green, blue (RGB) images. The single-camera configuration may provide cost-effective imaging while maintaining high-resolution capture. The imaging system 120 may be configured to capture a plurality of images reflected from the parabolic mirror 130 at different orientations of the parabolic mirror 130. Each captured image may correspond to a specific configuration of the mirror orientation actuators 150 and the linear actuator 160.

Each of the plurality of captured images may have a different distortion pattern corresponding to the parabolic mirror 130's respective orientation. The different distortion patterns may result from varying angular relationships among the parabolic mirror 130, the imaging system 120, and the target objects during inspection operations. The processing system 300 may compensate for each different distortion pattern based on the corresponding positional information received from the actuator encoders and position sensing systems.

The processing system 300 may generate partial three-dimensional reconstructions from individual captured images corresponding to different orientations of the parabolic mirror 130. Each individual captured image may be processed to extract depth information and spatial relationships specific to the mirror orientation and camera configuration at the time of capture. The processing system 300 may register the partial three-dimensional reconstructions in a common coordinate frame using the corresponding positional information from the actuator systems.

As further shown in FIG. 4, the three-dimensional depth information may comprise texture information that preserves color and appearance features for comprehensive inspection capabilities. Texture information may enable the detection of surface conditions, material properties, and visual indicators such as labels, gauges, and component markings. The combination of depth and texture information may provide complete characterization of target objects for inspection and monitoring applications.

The processing system 300 may spatially align partial three-dimensional reconstructions using corresponding positional information from the actuator encoders and position-sensing systems. The spatial alignment process may utilize the known geometric relationships between different mirror orientations and camera positions to register multiple partial reconstructions. The processing system 300 may generate a mesh surface from the spatially aligned partial three-dimensional reconstructions, creating continuous three-dimensional models of target objects and inspection regions.

The processing system 300 may generate quality metrics, including coverage assessment, surface smoothness evaluation, and mean sample points per area calculations. The coverage assessment may quantify the number of holes or gaps in the reconstructed surface to evaluate completeness. The surface smoothness evaluation may measure geometric consistency and continuity across the reconstructed mesh. The mean sample points per area calculations may assess the density of depth measurements and reconstruction resolution across different regions of the target object.

The coordinated motion of the mirror and camera subsystems may capture multiple views of target regions, thereby enhancing reconstruction and inspection accuracy. The resulting trajectory may enable visualization of areas that may be difficult to access with conventional imaging approaches. The trajectory may be illustrated by dashed lines with arrows that demonstrate the synchronized movement of the parabolic mirror 130 and the imaging system 120 to achieve comprehensive coverage of inspection targets in constrained environments.

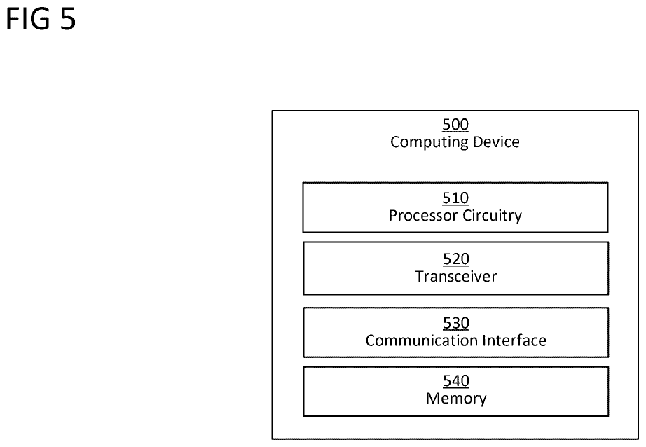

Referring to FIG. 5, a computing device 500 may be implemented within the robotic inspection system 100 to process sensor data, control actuators, and manage communication with external systems. The computing device 500 may provide the computational infrastructure for executing neural network inference, trajectory planning, and quality metric evaluation during inspection operations. The computing device 500 may be integrated within the mobile robotic platform 110 or distributed across multiple processing units, depending on application requirements and computational demands.

The computing device 500 may include processor circuitry 510 that executes instructions and performs computational operations for the robotic inspection system 100. The processor circuitry 510 may implement neural network inference algorithms to process distorted images captured by the parabolic mirror 130 and generate three-dimensional depth information. The processor circuitry 510 may also execute trajectory planning algorithms that coordinate the mirror orientation actuators 150 and the linear actuator 160 during inspection operations. In some cases, the processor circuitry 510 may perform quality metric evaluation, including point cloud density calculations, coverage completeness assessment, reconstruction uncertainty analysis, and depth estimation confidence measurements.

As shown in FIG. 5, the computing device 500 may further include a transceiver 520 that enables wireless communication capabilities for transmitting and receiving data between system components and external networks. The transceiver 520 may facilitate communication between the robotic inspection system 100 and edge computing servers for distributed processing operations. The transceiver 520 may also enable coordination between multiple robotic inspection systems 100 operating within the same facility or inspection area. In some cases, the transceiver 520 may support various wireless communication protocols, including Wi-Fi, cellular, and industrial wireless standards, suitable for different operational environments.

The computing device 500 may include a communication interface 530 that facilitates data exchange with external systems or networks. The communication interface 530 may enable coordination with edge computing servers where image embeddings may be transmitted for AI-based processing to optimize energy-to-workload ratios. The communication interface 530 may also support communication with other robotic agents in multi-robot inspection scenarios. The communication interface 530 may implement various communication protocols and data formats suitable for industrial automation and robotic system integration.

With continued reference to FIG. 5, the computing device 500 may comprise memory 540 that stores data, instructions, neural network models, and other information used during operation. The memory 540 may store point-of-interest configurations from the facility collection 201, including 14-dimensional vectors that define robot base positions, mirror configurations, and camera parameters. The memory 540 may also store calibration parameters for the parabolic mirror 130 and the imaging system 120, enabling accurate compensation for non-linear distortion during image processing. In some cases, the memory 540 may store reconstruction results, including partial point cloud views 209, mesh surfaces, and quality metrics computed during inspection operations.

The processor circuitry 510, the transceiver 520, the communication interface 530, and the memory 540 may be interconnected within the computing device 500 to enable coordinated functionality. The interconnected components may support real-time processing requirements during inspection operations while maintaining communication with external systems and managing data storage needs. The computing device 500 may implement distributed processing architectures in which computational tasks are partitioned between on-board processing and external computing resources based on workload characteristics and performance requirements.

The computing device 500 may implement Application-Specific Integrated Circuit (ASIC)-based on-board estimation or edge partition configurations for workload-specific optimization. ASIC implementations may provide dedicated hardware acceleration for neural network inference, enabling efficient processing of distorted images and depth estimation. Edge partition configurations may distribute computational tasks between the computing device 500 and external edge computing servers, thereby optimizing processing loads based on available computational resources and communication bandwidth. The workload-specific optimization may enable the robotic inspection system 100 to adapt processing strategies based on inspection complexity, target object characteristics, and operational constraints.

The processing system 300 may implement workload aggregation, in which multiple robotic agents connect to a single AI engine for scalable processing. This aggregation approach may enable cost-effective deployment of multiple robotic inspection systems 100 that share computational resources through a centralized processing infrastructure. The workload aggregation may utilize the communication interface 530 and the transceiver 520 to coordinate data transmission and processing requests between multiple robotic agents and shared computing resources. In some cases, workload aggregation enables specialized processing capabilities that may not be feasible for individual robotic platforms due to computational or cost constraints.

The robotic inspection system 100 may be designed for specific industrial environments, including semiconductor cleanrooms, energy and utilities infrastructure, and chemical processing facilities, where flying devices are restricted. In semiconductor cleanrooms, the robotic inspection system 100 may operate without generating air turbulence that could contaminate sensitive manufacturing processes. The robotic inspection system 100 may be configured to navigate narrow passages and confined spaces common in energy and utilities infrastructure, where conventional inspection methods may be limited by spatial constraints. In chemical processing facilities, the robotic inspection system 100 may provide inspection capabilities in environments where explosion risks or safety air flows restrict the use of flying devices. The mobile robotic platform 110 may be configured with appropriate materials and safety certifications for operation in these specialized industrial environments.

The techniques described in this disclosure may also be illustrated in the following examples.

Example 1. A robotic inspection system, comprising: a robotic platform; a non-planar optical element mounted to the robotic platform via a multi-degree-of-freedom actuator system, wherein the multi-degree-of-freedom actuator system is configured to controllably position and orient the non-planar optical element, and wherein the non-planar optical element is configured to introduce non-linear distortion into reflected images; an imaging system comprising a camera, the imaging system mounted to the robotic platform and configured to capture a plurality of images reflected from the non-planar optical element at different orientations of the non-planar optical element; and a processing system configured to: receive the plurality of captured images from the imaging system; receive positional information corresponding to the different orientations of the non-planar optical element and the imaging system; and process the plurality of captured images in combination with the corresponding positional information to compensate for the non-linear distortion and generate three-dimensional depth information of a target object within a field of view of the imaging system.

Example 2. The robotic inspection system of example 1, wherein the three-dimensional depth information comprises texture information.

Example 3. The robotic inspection system of any one or more of examples 1-2, wherein the imaging system comprises a single camera configured to capture red, green, blue (RGB) images.

Example 4. The robotic inspection system of any one or more of examples 1-3, wherein each of the plurality of captured images has a different distortion pattern corresponding to its respective orientation of the non-planar optical element, and wherein the processing system compensates for each different distortion pattern based on the corresponding positional information.

Example 5. The robotic inspection system of any one or more of examples 1-4, wherein the processing system is further configured to: generate partial three-dimensional reconstructions from individual captured images corresponding to different orientations of the non-planar optical element; and register the partial three-dimensional reconstructions in a common coordinate frame using the corresponding positional information.

Example 6. The robotic inspection system of any one or more of examples 1-5, further comprising a trajectory control system configured to dynamically control the multi-degree-of-freedom actuator system based on an accuracy metric to adjust viewpoints of the target object.

Example 7. The robotic inspection system of any one or more of examples 1-6, wherein the trajectory control system comprises: a neural controller configured to generate actuator control commands based on the accuracy metric and captured images; and a collision avoidance controller configured to ensure collision-free motion execution.

Example 8. The robotic inspection system of any one or more of examples 1-7, wherein the accuracy metric comprises point cloud density, coverage completeness, reconstruction uncertainty, or depth estimation confidence.

Example 9. The robotic inspection system of any one or more of examples 1-8, wherein the processing system comprises a neural network configured to process the plurality of captured images and the corresponding positional information to generate the three-dimensional depth information.

Example 10. The robotic inspection system of any one or more of examples 1-9, wherein the neural network comprises: a configuration encoder configured to encode the positional information into a configuration vector; a visual encoder configured to process the captured images to generate scene embeddings; and a decoder configured to combine the configuration vector and scene embeddings to compensate for the non-linear distortion and generate per-pixel depth estimates with texture information in a coordinate frame of the robotic platform.

Example 11. The robotic inspection system of any one or more of examples 1-10, wherein the neural network is trained using simulation-based learning with ray optics modeling of the non-planar optical element to generate training data with ground truth depth annotations, and wherein the trained neural network is configured to operate on real-world captured images.

Example 12. The robotic inspection system of any one or more of examples 1-11, wherein the non-planar optical element comprises a non-planar reflective mirror.

Example 13. The robotic inspection system of any one or more of examples 1-12, wherein the multi-degree-of-freedom actuator system is configured to provide at least five degrees of freedom to controllably position and orient the non-planar optical element.

Example 14. The robotic inspection system of any one or more of examples 1-13, wherein the multi-degree-of-freedom actuator system comprises: a linear actuator configured to provide extension and retraction of the non-planar optical element; a first rotational actuator configured to provide pan movement; a second rotational actuator configured to provide tilt movement; and two additional rotational actuators configured to provide angular orientation control at a base of the non-planar optical element.

Example 15. The robotic inspection system of any one or more of examples 1-14, further comprising a second multi-degree-of-freedom actuator system configured to control the imaging system.

Example 16. The robotic inspection system of any one or more of examples 1-15, wherein the processing system is further configured to: spatially align partial three-dimensional reconstructions using the corresponding positional information; and generate a mesh surface from the spatially aligned partial three-dimensional reconstructions.

Example 17. The robotic inspection system of any one or more of examples 1-16, wherein the robotic inspection system is configured to reposition the robotic platform when the accuracy metric fails to exceed a predetermined threshold within a specified time limit.

Example 18. The robotic inspection system of any one or more of examples 1-17, wherein the robotic platform comprises a mobile robotic platform configured to navigate to inspection locations.

Example 19. The robotic inspection system of any one or more of examples 1-18, wherein the non-planar optical element enables imaging of the target object at distances closer than a minimum focus distance of the imaging system operating without the non-planar optical element.

Example 20. The robotic inspection system of any one or more of examples 1-19, wherein the processing system is configured to operate in real-time during image capture operations to provide feedback to the trajectory control system for improving three-dimensional reconstruction quality during operation.

A number of implementations have been described. Nevertheless, it will be understood that various modifications may be made without departing from the spirit and scope of the disclosure. Accordingly, other implementations are within the scope of the following claims.

1. A robotic inspection system, comprising:
a robotic platform;
a non-planar optical element mounted to the robotic platform via a multi-degree-of-freedom actuator system, wherein the multi-degree-of-freedom actuator system is configured to controllably position and orient the non-planar optical element, and wherein the non-planar optical element is configured to introduce non-linear distortion into reflected images;
an imaging system comprising a camera, the imaging system mounted to the robotic platform and configured to capture a plurality of images reflected from the non-planar optical element at different orientations of the non-planar optical element; and
a processing system configured to:
receive the plurality of captured images from the imaging system;
receive positional information corresponding to the different orientations of the non-planar optical element and the imaging system; and
process the plurality of captured images in combination with the corresponding positional information to compensate for the non-linear distortion and generate three-dimensional depth information of a target object within a field of view of the imaging system.

2. The robotic inspection system of claim 1, wherein the three-dimensional depth information comprises texture information.

3. The robotic inspection system of claim 1, wherein the imaging system comprises a single camera configured to capture red, green, blue (RGB) images.

4. The robotic inspection system of claim 1, wherein each of the plurality of captured images has a different distortion pattern corresponding to its respective orientation of the non-planar optical element, and wherein the processing system compensates for each different distortion pattern based on the corresponding positional information.

5. The robotic inspection system of claim 1, wherein the processing system is further configured to:
generate partial three-dimensional reconstructions from individual captured images corresponding to different orientations of the non-planar optical element; and
register the partial three-dimensional reconstructions in a common coordinate frame using the corresponding positional information.

6. The robotic inspection system of claim 1, further comprising a trajectory control system configured to dynamically control the multi-degree-of-freedom actuator system based on an accuracy metric to adjust viewpoints of the target object.

7. The robotic inspection system of claim 6, wherein the trajectory control system comprises:
a neural controller configured to generate actuator control commands based on the accuracy metric and captured images; and
a collision avoidance controller configured to ensure collision-free motion execution.

8. The robotic inspection system of claim 6, wherein the accuracy metric comprises point cloud density, coverage completeness, reconstruction uncertainty, or depth estimation confidence.

9. The robotic inspection system of claim 1, wherein the processing system comprises a neural network configured to process the plurality of captured images and the corresponding positional information to generate the three-dimensional depth information.

10. The robotic inspection system of claim 9, wherein the neural network comprises:
a configuration encoder configured to encode the positional information into a configuration vector;
a visual encoder configured to process the captured images to generate scene embeddings; and
a decoder configured to combine the configuration vector and scene embeddings to compensate for the non-linear distortion and generate per-pixel depth estimates with texture information in a coordinate frame of the robotic platform.

11. The robotic inspection system of claim 9, wherein the neural network is trained using simulation-based learning with ray optics modeling of the non-planar optical element to generate training data with ground truth depth annotations, and wherein the trained neural network is configured to operate on real-world captured images.

12. The robotic inspection system of claim 1, wherein the non-planar optical element comprises a non-planar reflective mirror.

13. The robotic inspection system of claim 1, wherein the multi-degree-of-freedom actuator system is configured to provide at least five degrees of freedom to controllably position and orient the non-planar optical element.

14. The robotic inspection system of claim 13, wherein the multi-degree-of-freedom actuator system comprises:
a linear actuator configured to provide extension and retraction of the non-planar optical element;
a first rotational actuator configured to provide pan movement;
a second rotational actuator configured to provide tilt movement; and
two additional rotational actuators configured to provide angular orientation control at a base of the non-planar optical element.

15. The robotic inspection system of claim 1, further comprising a second multi-degree-of-freedom actuator system configured to control the imaging system.

16. The robotic inspection system of claim 1, wherein the processing system is further configured to:
spatially align partial three-dimensional reconstructions using the corresponding positional information; and
generate a mesh surface from the spatially aligned partial three-dimensional reconstructions.

17. The robotic inspection system of claim 6, wherein the robotic inspection system is configured to reposition the robotic platform when the accuracy metric fails to exceed a predetermined threshold within a specified time limit.

18. The robotic inspection system of claim 1, wherein the robotic platform comprises a mobile robotic platform configured to navigate to inspection locations.

19. The robotic inspection system of claim 1, wherein the non-planar optical element enables imaging of the target object at distances closer than a minimum focus distance of the imaging system operating without the non-planar optical element.

20. The robotic inspection system of claim 6, wherein the processing system is configured to operate in real-time during image capture operations to provide feedback to the trajectory control system for improving three-dimensional reconstruction quality during operation.
